(19) United States
(12) Patent Application Publication
(10) Pub. No.: US 2013/0173638 A1
(43) Pub. Date: Jul. 4, 2013

(54) ENTITY IDENTIFICATION BASED ON LOCATION

(71) Applicant: MINTIGO LTD., Ra'anana (IS)

(72) Inventor: Ehud Ben-Reuven, New York, NY (US)

(73) Assignee: MINTIGO LTD., Ra'anana (IS)

(21) Appl. No.: 13/716,268

(22) Filed: Dec. 17, 2012

Related U.S. Application Data
(60) Provisional application No. 61/581,102, filed on Dec. 29, 2011.

(51) Int. Cl. G06F 17/30

(52) U.S. Cl. CPC G06F 17/3053
USPC 707/749

(57) ABSTRACT

A method and system for estimating a score that a first entity is related to a second entity. The method includes steps of extracting a first property from a first entity, extracting a second property from a second entity, estimating a geo location of the first entity based on the first property, estimating a geo location of the second entity based on the second property, comparing the estimated geo location of the first entity with the estimated geo location of the second entity, and associating a score for the first entity to be related to the second entity based on the result of the comparison.

### RELATED APPLICATIONS

This application claims all rights of priority to U.S. Provisional Patent Application No. 61/581,102 filed on Dec. 29, 2011, which is fully incorporated herein by reference.

### FIELD OF THE INVENTION

The presently disclosed principles and inventions are related to business analytics, and more particularly, to methods for converting a known information about at least two entities into a score signifying that the first entity is the same as the second entity or a member of the second entity.

### BACKGROUND OF THE INVENTION

In many cases partial information is supplied about a first entity and a question arises if this entity is a member of or the same as another i.e., second, entity for which other partial information is known. However, in many cases the partial information supplied for the two entities cannot, be directly compared. The presently disclosed invention resolves the above problem in the prior art.

### SUMMARY OF THE INVENTION

In one general aspect, the invention provides a method of entity identification which includes converting a partial information received for each entity into a location information and then comparing the locations of the two entities to assign a score signifying that the first entity is the same as the second entity or a member of the second entity.

In one specific aspect, the partial information known for each of the two entities is the street address. A solution known in the art is to compare the street addresses, allowing for the differences in the way the address are represented. However, directly comparing the street addresses can be hard to implement. In accordance with one aspect of the invention, it uses an external service to convert the two street addresses into geo location information and then to compare the locations to determine if the two entities are co-located and therefore, are likely to be the same.

In another specific aspect, the partial information about each entity is different in kind and cannot be compared directly. For example, whenever a business detects Internet traffic directed to one of its Internet facilities, it can derive the IP address from which the traffic has originated. Existence of such traffic indicates that the entity (person, organization, business or government) using this IP address is possibly interested in interacting, is a potential marketing or sales lead, or is perhaps, a security threat or a business competitor. Therefore, knowing the identity of the entity behind the IP address is a valuable information for the business.

IP address can be used to identify the entity using Internet services, for example, by implementing the WHOIS protocol (RFC 3912). However, these services in many cases, supply information about the ISP supplying the Internet connectivity to the entity, and do not supply direct information about the entity itself. In other words, there is no direct information that can be compared with the IP address of the unknown entity. In accordance with another aspect of the present invention, there is a list of potential second entities, for example, a list of all of potential customers of a business or a list of all of potential competitors of the business. The entities in the list have known information, for example, a business address which, in accordance with the invention, can be converted into a geo-location information. The method of the present invention estimates the location of the first entity based on its IP address, compares the entity's estimated geo location to the locations associated with the entities in the known list. The comparison is then utilized to give a probability of a relationship between the entity, behind the IP address, and each entity on the list.

### BRIEF DESCRIPTION OF DRAWINGS

The invention is illustrated in the figures of the accompanying drawings which are meant to be exemplary and not limiting, in which like references are intended to refer to like or corresponding parts, and in which:

FIG. 1 is a flowchart illustrating a method for estimating the score of an entity to be related to another entity based on the estimated location of the entities.

FIG. 2 is a flowchart illustrating a method for estimating the score of an entity to be related to entities in a list based on an IP address, in accordance with one embodiment of the present invention.

FIG. 3 is a schematic diagram illustrating the system in accordance with one preferred embodiment of the present invention.

### DETAILED DESCRIPTION OF THE EMBODIMENTS

in the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

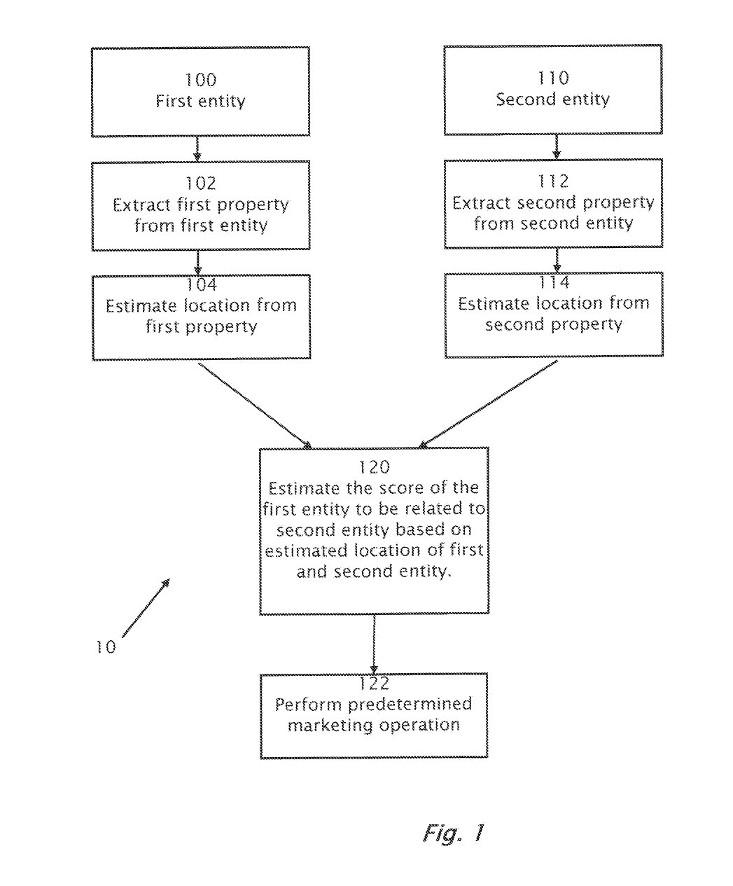

Referring now to the drawings, in which like numerals represent the same or similar elements, and, initially, to FIG. 1, in which an exemplary method 10 is illustrated for determining if a first entity 100 and a second entity 110 are related. A property (or feature) is extracted from the first entity (Step 102) and from the second entity (Step 112). The task of comparing the two properties directly can be hard. For example, the two extracted properties may be home addresses of people but, since there are many different was to enter the same address, it is likely that a direct comparing of the two addresses will result in false negative errors. In other cases, the two properties can be unrelated and comparing them directly is impossible. For example, the first property may be a mobile cell phone tower used to make a phone call and the second property may be a mailing address of a business:

In accordance with the preferred embodiment of the invention, the two properties are converted into an estimated geographical location of the entity (geo location) (Steps 104, 114). The geo location may be represented as a latitude-longitude coordinate. There are runny techniques known in the art for converting, various properties into an estimated geo location. For example, an address can be converted into a geo location using techniques known in the art. Also in accordance with a known technique, location of a tower in a mobile cell-phone network and the signal it receives can be converted into an estimated geo location of the cell phone generating the signal.

Similarly, an IP address of a network transaction can be converted into a geo location. One known technique for converting an JP address into a geo location includes construction of a table or a database of ranges of IP addresses and their corresponding geo locations. In accordance with this technique, if the system receives (or detects) a specific IP address, it then looks for an entry in the table that includes in its range this IF address, and then uses the geo location stored in the table as an estimate for the geo location of the received IP address. Each entry can be assigned a weight (for example, a radius of the geo location assigned to the entry), then, if a query for a particular IP address, returns several geo location entries, the system will use the entry with the best weight. For example, it will use the entry with the best (smallest) radius. The entire geo location lookup process is preferably performed as a service on a remote computer. Therefore, in accordance with method 10, Steps 104 and 114 may be performed by sending a query to that er ice and waiting for its response.

Once the estimated geo locations of the first and second entities are known, an estimate can be made if the two entities are related, if they are the same, if the first entity is a member of the second or if the two entities are unrelated (Step 120). The estimate may be weak but in ma marketing situations even a small improvement in identify a target can lead to significant results and, therefore, any estimation of the score, which is above what is known in advance (prior probability), is desirable.

For example, to determine whether a person works in a particular company based on the geo location information, the system first collects the location (or locations) of the company. Next, the system receives a training-set, which is a list of all known employees of the company with a known geo location. The system then utilizes the training set to build a statistical model of the score for the person being employed by the company based on his/her geo location and the company's geo location(s). There are many techniques known in the art for building such a model. One technique is to convert the geo location information of a person and of the company to a distance, and then to use the training set to estimate the standard deviation of the distance measured from the training set. Once the standard deviation is known, an estimate of a probability, for a new person can be determined from the following equation:

Probability to get a distance reading given that a person is working in company A is proportional to exp (−distance*distance/(standard deviation*standard deviation))

Bayes term can then be used to compute the probability of a person working in company A: Probability that a person is working a company A given a distance reading is the same as Probability, to get a distance reading given that a person is working in company A divided by the sum on all companies of Probability to get a distance reading given that a person is working in a company.

When estimating the probability, it is possible to use estimations of the errors made in steps 104 and 114.

When estimating the probability of the first entity to be related to the second entity, it is possible to use a prior probability that such a relation exists. The usage of a prior probability is significant if there is more than one option for the second entity and it is assumed that the first entity is related to one of the options.

Based or the determined score, the system then performs a predetermined marketing operation (Step 122). For example, a particular marketing message may be associated with each score range, and, when the above-determined score falls into one of the predetermined ranges, the message associated with this score is displayed to the first entity. The message is preferably calculated to target the business of the second entity.

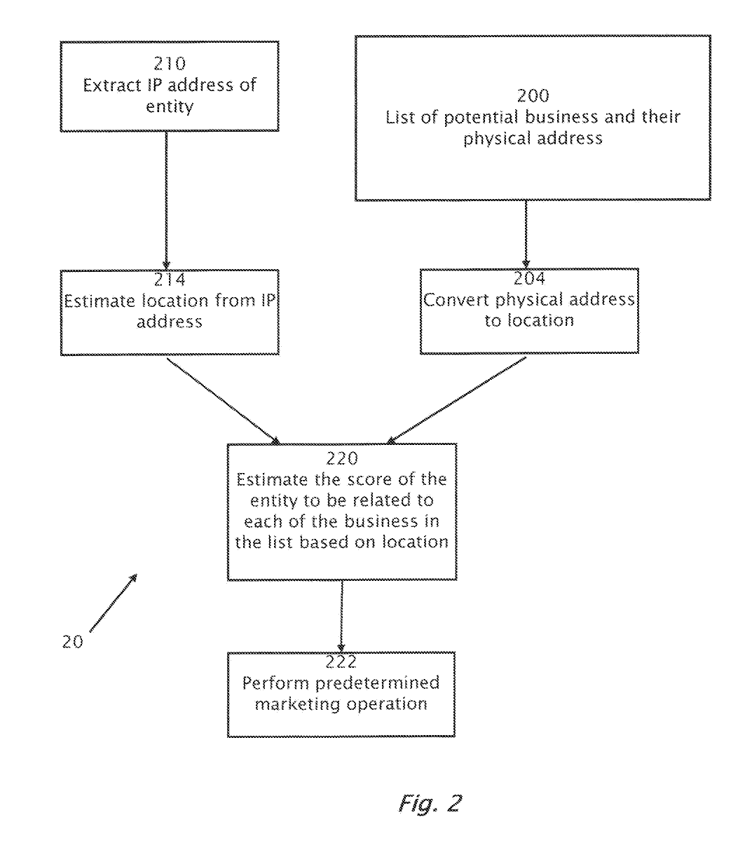

Moving on to FIG. 2, an exemplary method 20 is illustrated for determining if an entity is related to businesses in a predetermined list 200 based on the entity's IP address. In the preferred embodiment, Internet traffic generated or received by an entity is first intercepted and an IP address used by the entity is extracted (Step 210). The interception is most likely to happen on a web site that is run by a company that is interested in the result of this method. The company can estimate which business, to which the entity is related, is interested in the content of the company's site even if no other indication was left behind by the entity while visiting the site. The company can then use this information to direct its marketing and sales operations at the business.

The geo location of the entity is estimated based on its IP address 214, this can be done using on-line services that perform such estimations or by keeping a table that maps range of IP address to estimated geo-locations, it is possible for the entity to use a proxy that hides its true IP address. In these cases, it may be possible to extract the original IP address of the entity from the information generated by the proxy.

The geo location of the businesses within the list 200 is also extracted (Step 204). In some cases, commercial databases already supply this information. In other cases, the office address of the business can be converted into a geo location using one of the techniques known in the art.

Some businesses may have multiple locations that can all be candidates for comparison with the location of the entity.

Finally, estimation is made (Step 220) for the score of the entity to be related to represent any of the businesses on the list 200. This estimation can be based on the assumption that the entity is acting from the business office or that is living in a nearby location to the office.

Based on the determined score, the system then performs a predetermined marketing operation (Step 222). For example, a particular marketing message may be associated with each score range, and, when the above-determined score fails into one of the predetermined ranges, the message associated with this score is displayed to the entity. The message is preferably calculated to target the businesses from the list 200.

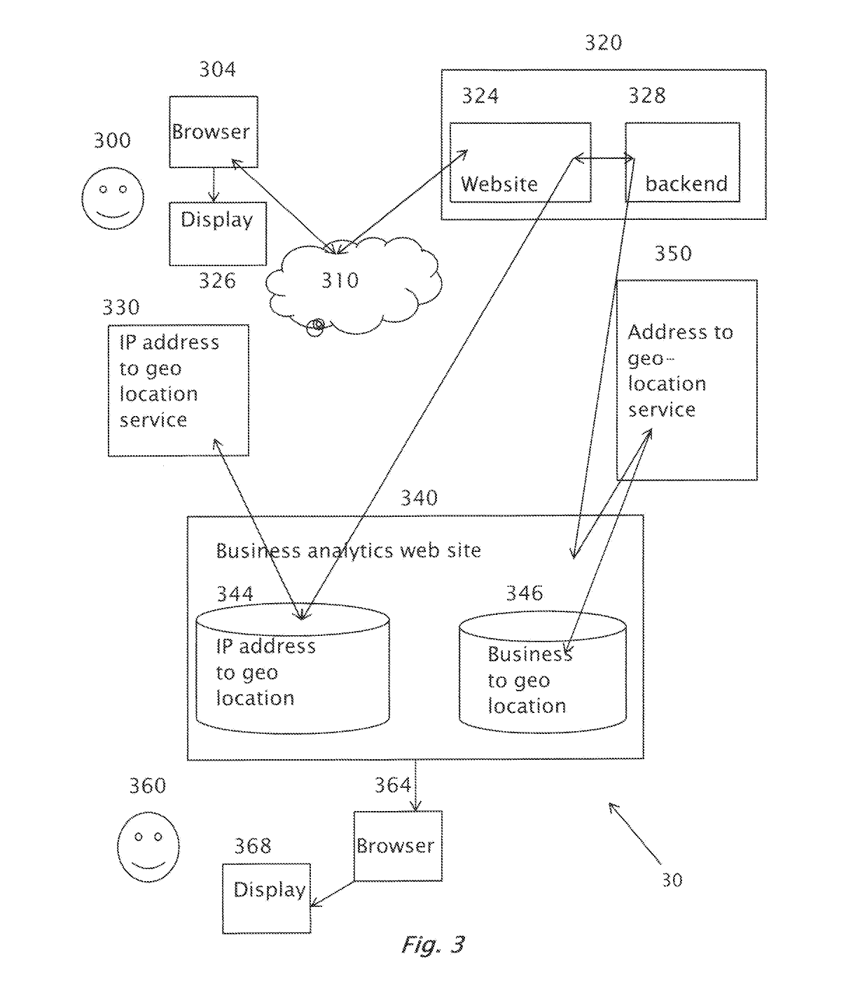

An exemplary embodiment of the system 30 of the present invention is illustrated in FIG. 3. System 30 can be utilized for furnishing sales or marketing information. As shown in FIG. 3, a user 300 uses his/her browser 304 to visit a web site 324 of the company 320 using the Internet 310. The visitor may be a potential customer of the products or services sold by a company 320. In the case in which company 320 is selling products or services to other businesses, it may have a list of the businesses which are current or potential customers. This list is managed and stored at a back-end server 328 of the company. Information stored in the back-end server may be collected from the web site's visitors 300, using a special customer information form. Alternatively, this information can be collected from other sources. However, a business identity of most visitors is not typically known. Networking information about the site's visitor is sent from the server of the website 324 to a special business analytics web site 340. The networking information typically includes an IP address of the visitor's browser 304. Alternatively, the content of the web page presented by the web site 324 to the visitor's browser 304 may contain instructions causing the browser 304 to directly access the analytics web site 340. For example, the web page can contain a small picture that is located in the analytics web site and which is made to be invisible to the visitor 300 by the browser 304.

The company 320 supplies information on various business entities of interest to the analytics web site 340, thus forming a list of business entities potentially associated with and/or of interest to company 320. The information may come from the company's back-end server 328 or from other sources. The analytics site 340 can extend the list using additional external sources. The analytics site 340 enriches the list content with one or more business address for each business entity on the list. The analytics site then uses an external service 150 to convert the business address into a geo location, as described above. The resulting one or more geo location information for each business of interest is stored in a special database 346.

The analytics site 340 also uses an external service 330 to build a database 344 in which ranges of IP address are mapped to geo location information. The analytics site then uses the database to convert the IP address of the visitor 300 into a geo location information for the visitor. Finally, the server of the analytics site 340 compares the geo location information of the visitor 300 with the geo location information of various businesses of interest stored in the database 346. All businesses on the list are ranked based on the geo location information (a higher geo proximity corresponding to a higher ranking) and the resulting ranking is then displayed on a display 368 of a sales or marketing representative 360 of the company 320. Presentation of this information can be performed with a browser 364.

Further, based on the determined score, system 30 then performs a predetermined marketing operation. For example, a particular marketing message may be associated with each score range, and, when the above-determined score falls into one of the predetermined ranges, the message associated with this score is displayed to the user 300. The message is preferably calculated to target the businesses identity of the user 300.

The figures in this disclosure are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations; computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Those skilled in the art will appreciate that the invention may be practiced in network computing environments with many types of computer system configurations, including mobile telephones. PDA, pagers, hand-held de ices, laptop computers, personal computers, multi-processor Systems, microprocessor-based or programmable consumer electronics, network PCs, minicomputers, mainframe computers, and the like. The invention may also be practiced in distributed computing environments where local and remote computer systems which are linked (either by hardwired links, wireless links, or by a combination of hardwired or wireless links) through a communication network, both perform tasks. In a distributed computing environment, program modules may be located in both local and remote memory storage devices.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying Knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above described exemplary embodiments, but should be defined only in accordance with the following claims and their equivalents.

What is claimed is:

1. A method for estimating a score representing relatedness between a first entity and a second entity, the method comprising the steps of:
a. extracting a first property from a first entity;
b. extracting a second property from a second entity;
c. estimating a geo location of the first entity based on be first property;
d. estimating a geo location of the second entity based on the second property;
e. comparing the estimated geo location of the first entity with the estimated geo location of the second entity; and
f. associating a score for the first entity to be related to the second entity based on a result of the comparison.

2. The method as recited in claim 1, further comprising a step of extracting the first property from a network traffic of the first entity.

3. The method as recited in claim 2, wherein the first property extracted from the network traffic is IP address used by the first entity.

4. The method as recited in claim 1, farther comprising a step of displaying a predetermined information associated with said score on a display device of the first entity.

5. Method of estimating relationship between two entities the method comprising the steps of:
intercepting an Internet traffic generated or received by a first entity;
extracting an IP address used by the first entity;
estimating a geo location of the first entity based on its IP address;
providing a list of second entities;
extracting a geo location for each second entity on the list; and
using the goo location of the first entity and the extracted geo locations of the second entities to estimate a score of the first entity to be related to any of the second entities on the list.

6. The method of claim 5, wherein the step of estimating the geo location of the first entity further comprises keeping a table mapping a range of IP address to estimated geo-locations.

7. The method of claim 5, wherein the step of extracting the geo location for each second entity comprise a step of deriving the geo location for the second entity from commercial databases.

8. The method of claim 5, wherein the step of extracting the geo location for each second entity comprises a step of convening an office address of the second entity into the geo location of the second entity.

9. The method as recited in claim 9, further comprising a step of displaying a predetermined information associated with said score on a display device of the first entity.

10. A system for estimating relationship between two entities, the system comprising:
a first computing device operable to intercept an Internet traffic generated or received by a first entity, the first computing device being further operable to extract an IP address used by the first entity;
a second computing device operable to store a list of a plurality of second entities; and
a third computing device operable to estimate a geo location of the first entity based on its IP address, the third computing device being also operable to extract a geo location for each second entity on the list, the third computing device being further operable to estimate a score of date first entity being related to any of the second entities on the list by using the geo location of the first entity and the extracted geo locations of the second entities.

11. The system of claim 10, further comprising a database comprising a table mapping a range of IP address to estimated geo-locations.

12. The system of claim 10, further comprising a fourth computing operable to derive the geo locations for the second entities and to convey the derived geo locations to the third computing device.

13. The system of claim 10, wherein the first computing device and the second computing device are located on a company network.

14. The system of claim 13, wherein the third computing device is located outside of the company network.

15. The system of claim 10 further comprising a display device operable to display the estimated score of the first entity being related to any of the second entities on the list.

16. The method of claim 10 further comprising a second display device operable to display a predetermined information associated with said estimated score.
